(19) United States
(12) Patent Application Publication
(10) Pub. No.: US 2025/0389559 A1
(43) Pub. Date: Dec. 25, 2025

(54) SENSOR MODULE

(71) Applicant: HOSIDEN CORPORATION, OSAKA (JP)

(72) Inventor: Takumi IKEDA, Osaka (JP)

(21) Appl. No.: 19/233,323

(22) Filed: Jun. 10, 2025

(30) Foreign Application Priority Data
Jun. 25, 2024 (JP) 2024-101743

(51) Int. Cl. G01D 11/24; G01D 11/26; H01M 50/247; H01M 50/298

(52) U.S. Cl. CPC G01D 11/245; G01D 11/26; H01M 50/247; H01M 50/298

(57) ABSTRACT

This sensor module includes: a module case, a sensor unit mounted on a substrate surface of a substrate housed in the module case; a wireless communication unit mounted on the substrate surface, and a battery that is housed in the module case and supplies power to the sensor unit and the wireless communication unit. The battery is arranged at a position not overlapping the wireless communication unit in a view along a direction perpendicular to the substrate surface of the substrate.

### CROSS REFERENCE TO RELATED APPLICATION

This application is based on and claims priority under 35 U.S.C. Section 119 to Japanese Patent Application No. 2024-101743 filed on Jun. 25, 2024, the entire content of which are incorporated herein by reference.

### TECHNICAL FIELD

This disclosure relates to a sensor module.

### RELATED ART

As a technology related to sensor modules, JP 2017-21058A describes a foundation pile evaluation system that includes a detection device, which has a sensor for attachment to a foundation pile that has reinforcing bars, and an evaluation device that evaluates any abnormalities in the foundation pile based on detection information from the detection device.

In this foundation pile evaluation system, the foundation pile is a reinforced concrete pile or the like, the detection device is electrically connected to the reinforcing bars of the foundation pile, the battery of the detection device can be charged by power supplied via the reinforcing bars, and detection information can be extracted from the sensor via the reinforcing bars.

Also, JP 2002-139321A describes an electronic pile that includes a GPS unit having a GPS antenna, a correction information signal receiving unit that receives a correction information signal via a correction information receiving antenna and creates GPS position correction information, a position data etc. signal transmitting/receiving unit that transmits position data and receives instruction signals via a position data etc. transmitting/receiving antenna, and an electronic pile main unit that supplies power.

This electronic pile is used by being driven into the ground, has sensors for measuring temperature, humidity, and carbon dioxide gas concentration, and is configured to be able to establish a wireless connection to the Internet or the like. Therefore, even if the electronic pile moves, it is possible to correct the position of the electronic pile and acquire environmental data.

### SUMMARY

For example, it is possible to use the technologies described in JP 2017-21058A and JP 2002-139321A to acquire information such as temperature, humidity, and gas concentration at various installation locations without being limited in terms of the ground site.

Also, it is effective to use wireless communication technology to obtain information on various installation locations. In order to transmit information by wireless communication, it is necessary to provide a battery as a power source.

When considering a sensor module that acquires information using sensors and transmits the acquired information using a wireless communication technology, there is desire for the sensor module to be of an easy-to-handle size, be easy to assemble, and be capable of reliably performing wireless signal transmission.

However, JP 2017-21058A and JP 2002-139321A do not describe a configuration that gives consideration to space efficiency, ease of assembly, and reliable wireless information transmission. For example, the battery is a relatively large component of the sensor module, and the battery is thought to hinder wireless signal transmission.

For these reasons, there is a demand for a sensor module that can acquire information using a sensor unit, and transmit the acquired information wirelessly without being hindered by a battery.

A sensor module according to an aspect of this disclosure includes: a module case; a sensor unit mounted on a substrate surface of a substrate housed in the module case; a wireless communication unit mounted on the substrate surface; and a battery housed in the module case and configured to supply power to the sensor unit and the wireless communication unit, the battery being arranged at a position not overlapping the wireless communication unit in a view along a direction perpendicular to the substrate surface of the substrate.

According to this aspect, in the sensor module, using power supplied from the battery, the sensor unit can perform detection, and the wireless communication unit can perform wireless transmission of information. Furthermore, in the sensor module according to this aspect, the battery is arranged at a position not overlapping the wireless communication unit in a view along a direction perpendicular to the substrate surface, and therefore the battery does not hinder wireless signal transmission. Therefore, it is possible to provide the sensor module that acquires information with the sensor unit and wirelessly transmits the information without being hindered by the battery.

In addition to the above aspect, it is preferable that the wireless communication unit includes an antenna unit, and the battery is arranged at a position not overlapping the antenna unit in a view along the direction perpendicular to the substrate surface of the substrate.

According to this aspect, the battery is arranged at a position not overlapping the antenna unit in a view along a direction perpendicular to the substrate surface, thereby making it possible to reliably suppress a phenomenon in which the battery hinders radio wave transmission, and to favorably perform wireless signal transmission.

In addition to the above aspect, it is preferable that the module case includes: a tubular body case having an insertion-side opening in at least one end portion; and an inner frame configured to be housed in the body case by being inserted through the insertion-side opening, and the inner frame includes: a substrate arrangement portion extending in a direction in which the inner frame is inserted into the body case, and on which the substrate is disposed on a first side in the direction perpendicular to the substrate surface; a battery arrangement portion on which the battery is disposed from a second side in the direction perpendicular to the substrate surface; and an intermediate wall portion disposed between the substrate arrangement portion and the battery arrangement portion.

According to this aspect, the module case has the tubular body case and the inner frame that is inserted into the body case. Also, the inner frame has the substrate arrangement portion on which the substrate is arranged, the battery arrangement portion on which the battery is arranged, and the intermediate wall portion arranged between the substrate arrangement portion and the battery arrangement portion, and therefore the substrate can be arranged on the substrate arrangement portion and the battery can be arranged on the battery arrangement portion. Also, with this configuration, it is possible to arrange the substrate on the substrate arrangement portion on one side, in the direction perpendicular to the substrate surface, in the inner frame, and to arrange the battery on the battery arrangement portion on the other side, in the direction perpendicular to the substrate surface, in the inner frame.

In addition to the above aspect, it is preferable that the intermediate wall portion has an opening into which a power cable is insertable, the power cable being configured to supply power from the battery disposed on the battery arrangement portion to the substrate.

According to this aspect, the intermediate wall portion has the opening through which the power cable from the battery in the battery arrangement portion can be inserted, and therefore the power cable can be easily passed through the intermediate wall portion.

In addition to the above aspect, it is preferable that the substrate includes a power connector connectable to a power plug portion connected to the power cable, the power connector being provided on the substrate surface.

According to this aspect, by connecting the power plug portion provided at the end portion of the power cable to the power connector on the substrate surface, power can be supplied from the battery to the substrate. Also, since the power plug portion is connected to the power connector, the connection can be performed more easily than in a configuration in which, for example, wiring is connected by soldering.

In addition to the above aspect, it is preferable that the inner frame further includes an external connector at a position exposed through the insertion-side opening after the inner frame is inserted through the insertion-side opening of the body case, and the sensor module further has a cable space formed on a lateral side of the battery in the battery arrangement portion in response to the inner frame being inserted into the body case, the cable space being configured to accommodate an information cable configured to electrically connect the external connector and the substrate to each other.

According to this aspect, when the inner frame is housed in the body case, it is possible to connect a cable for acquiring external information or the like to the external connector at a position exposed through the insertion-side opening of the body case. Furthermore, since the information cable that electrically connects the external connector and the substrate to each other is disposed in the cable space on one lateral side of the battery in the battery arrangement portion, the information cable can be arranged easily.

In addition to the above aspect, it is preferable that the sensor unit, the wireless communication unit, and an information connector connectable to a connection plug portion connected to the information cable are mounted on the same substrate surface of the substrate.

According to this aspect, by connecting the connection plug, which is connected to a connection wire electrically connected to the external connector, to the information connector, it is possible to electrically connect the external connector and the substrate to each other. Furthermore, since the connection plug portion is connected to the information connector in this configuration, the connection can be performed more easily than in a configuration in which, for example, wiring is connected by soldering.

In addition to the above aspect, it is preferable that the body case has a through hole-shaped limiting wall opening in a limiting wall determining an insertion limit in response to the inner frame being inserted into the body case, the inner frame has a through hole-shaped inner wall opening in an inner wall adjacent to or in contact with the limiting wall in response to the inner frame being inserted up to the insertion limit, and the limiting wall opening and the inner wall opening are in an overlapping positional relationship in response to the inner frame being inserted up to the insertion limit.

According to this aspect, when the inner frame is inserted up to the insertion limit in the body case, the inner wall of the inner frame overlaps the limiting wall of the body case. Since the limiting wall opening of the limiting wall and the inner wall opening of the inner wall overlap in this manner, for example, a connector for acquiring information or the like can be inserted through the overlapping openings.

In addition to the above aspect, it is preferable that the sensor module further includes: a first annular seal configured to seal a gap between an outer peripheral surface of a portion of the inner frame in a vicinity of the insertion-side opening and an inner peripheral surface of the insertion-side opening of the body case while the inner frame is at the insertion limit in the body case; and a second annular seal configured to seal a gap between an outer peripheral surface of the body case and an inner peripheral surface of a cap configured to seal a limiting-side opening of the body case, the limiting-side opening being on a side opposite to the insertion-side opening.

According to this aspect, when the inner frame is inserted up to the insertion limit in the body case, the gap between the outer peripheral surface of the inner frame near the insertion-side opening and the inner peripheral surface of the insertion-side opening of the body case can be sealed with the first annular seal. Furthermore, when the limiting-side opening of the body case is closed by the cap, the gap between the outer peripheral surface of the body case and the inner peripheral surface of the cap can be sealed with the second annular seal. This makes it possible to prevent water and dust from entering the internal space of the body case.

In addition to the above aspect, it is preferable that the inner frame has a through hole in an outer wall formed on an end portion on a side opposite to the inner wall in the direction in which the inner frame is inserted, the through hole being closed by a membrane that allows air to pass through and does not allow water to pass through.

According to this aspect, air passes through the membrane in response to changes in the pressure (air pressure) outside the module case, thereby making it possible to equalize the pressure inside the module case with the external air pressure. This makes it possible to properly measure the air pressure outside the module case even in a configuration in which the air pressure sensor is provided on the substrate.

### BRIEF DESCRIPTION OF DRAWINGS

FIG. 1 is a cross-sectional view illustrating an outer case and a sensor module.

FIG. 2 is a cross-sectional view of the sensor module as viewed from a lateral direction.

FIG. 3 is a cross-sectional view of the sensor module as viewed from a front-rear direction.

FIG. 4 is an exploded perspective view of the outer case and the sensor module.

FIG. 5 is a perspective view of an inner frame having a substrate, as viewed from the inner wall side.

FIG. 6 is a cross-sectional view illustrating a limiting wall and an inner wall.

FIG. 7 is a cross-sectional view of the limiting wall and the inner wall in a separated state.

FIG. 8 is a cross-sectional view of a body case and the vicinity of an outer wall of the inner frame.

### DESCRIPTION OF EMBODIMENTS

Hereinafter, embodiments of a sensor module according to this disclosure will be described with reference to the drawings. The sensor module is not limited to the following embodiments, and various modifications can be implemented without departing from the spirit and scope of the invention.

### Basic Configuration

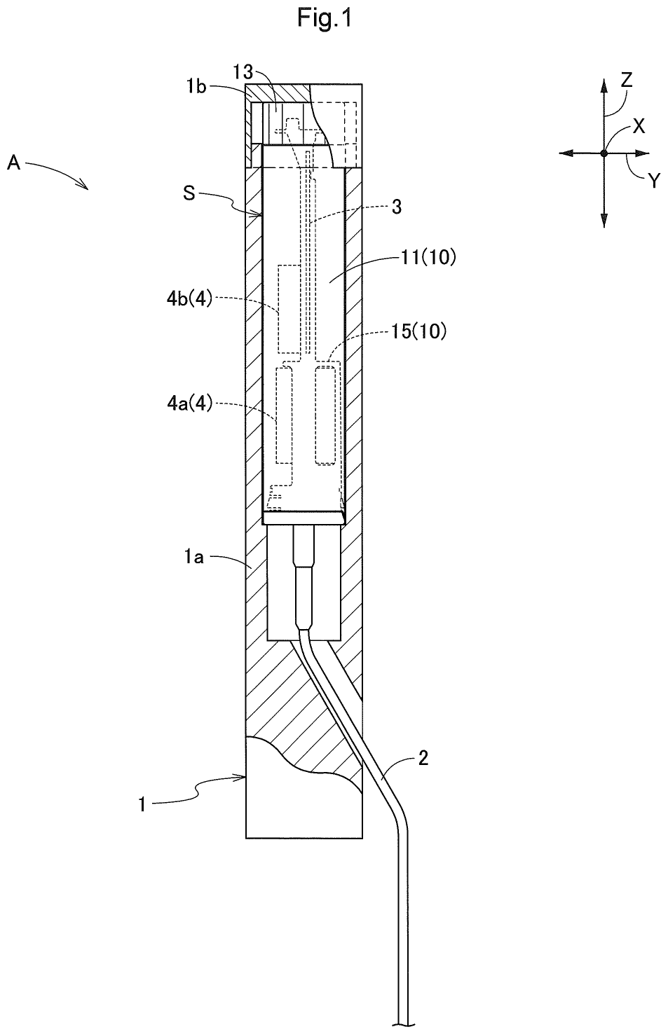

As shown in FIGS. 1 to 4, an information acquisition unit A is configured by housing a sensor module S in an outer case 1. The information acquisition unit A is installed inside a factory or outdoors, and transmits information detected by the internal sensor module S to an external device via wireless communication. Also, the sensor module S is configured to be able to receive wireless communication signals from an external device and perform necessary setting.

A plurality of information acquisition units A can be used to acquire information about a region in which the information acquisition units A are installed. When a plurality of information acquisition units A are used in this manner, information transmitted from the information acquisition units A via wireless communication is received by a management unit (not shown) located outside the information acquisition units A. The management unit identifies the location where each of the information acquisition units Ais installed based on information received from the sensor module S, and acquires environmental information for each installation location. This enables the management unit to analyze the environmental information and manage the environmental information. The management unit may be fixed or movable.

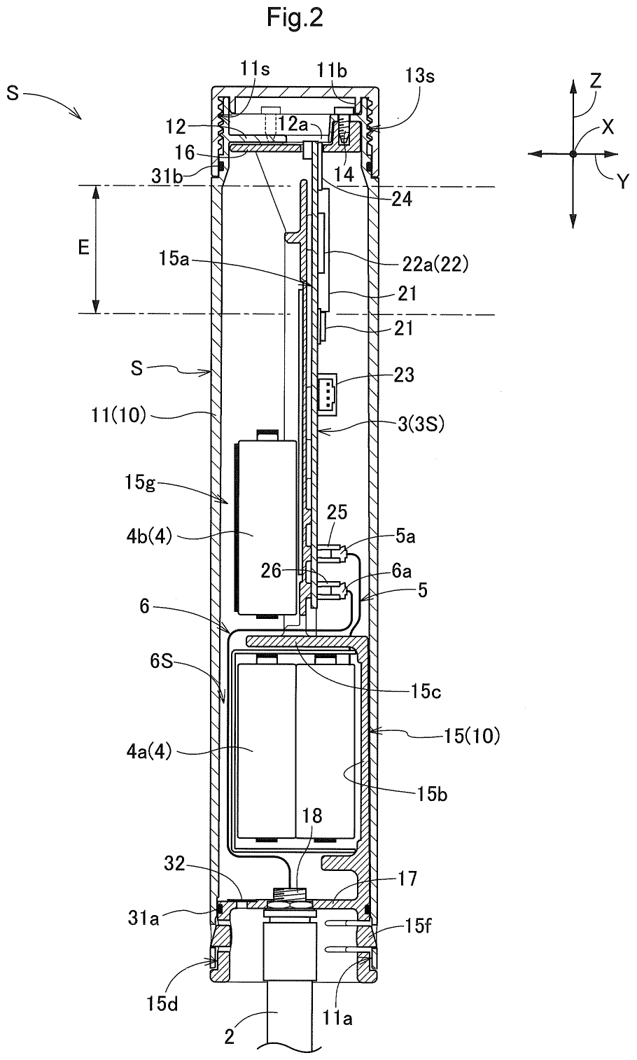

As shown in FIG. 2, the sensor module S is connected to an external cable 2, and the external cable 2 is drawn to the outside through a hole-like portion of the outer case 1. The external cable 2 can be connected to an external sensor (not shown), and the sensor module S is configured to be able to acquire information acquired by the external sensor via the external cable 2 and transmit the information via wireless communication.

Note that the sensor module S is also configured to be able to receive power from an external power source or the like via the external cable 2. The sensor module S is configured to be capable of operating with power received via the external cable 2, and to be capable of charging batteries 4 with the received power. The batteries 4 include a first battery pack 4a (an example of a battery) and a second battery pack 4b (an example of a battery). Note that the first battery pack 4a and the second battery pack 4b can be combined into one battery pack, and it is possible to omit either the first battery pack 4a or the second battery pack 4b.

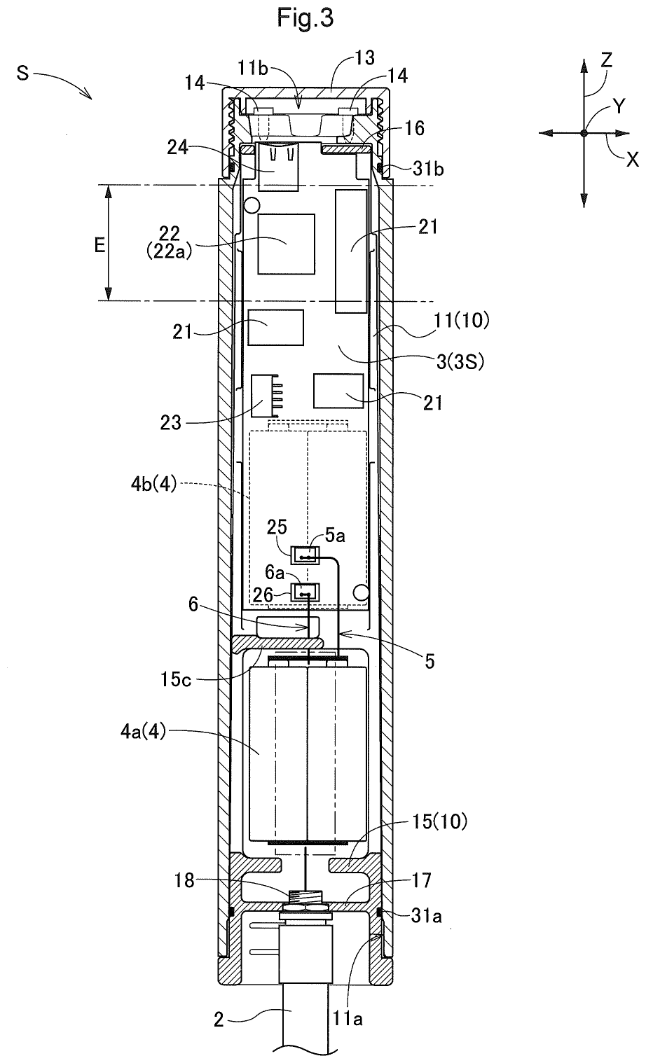

The outer case 1 is used in the posture shown in FIG. 1. For this reason, the horizontal direction extending along a substrate surface 3S of a substrate 3 shown in FIG. 3 will be called a lateral direction X, the horizontal direction perpendicular to the substrate surface 3S shown in FIG. 2 will be called a front-rear direction Y, and the up-down direction (the direction of gravity and the direction opposite thereto) will be called a vertical direction Z.

In the following description, the positional relationships between components of the sensor module S will be described based on these directions. In particular, in some cases, the lower side of the outer case 1 and the sensor module S in the vertical direction Z will be called the lower end, and the opposite side will be called the upper end.

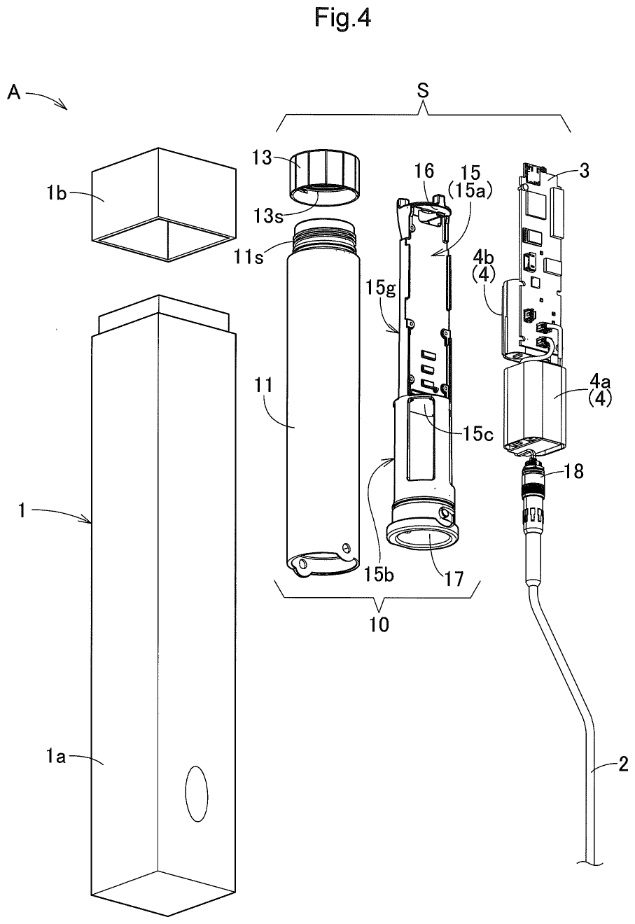

As shown in FIGS. 1 and 4, the outer case 1 has a case portion 1a and a lid portion 1b that closes an opening at the upper end of the case portion 1a.

### Sensor Module

As shown in FIG. 4, the sensor module S is configured by housing the substrate 3 and the batteries 4 in a cylindrical module case 10. As shown in FIGS. 2 to 4, the module case 10 has a cylindrical body case 11 and an inner frame 15 housed in the body case 11.

### Body Case of Sensor Module

The body case 11 is cylindrical and, as shown in FIGS. 2 and 3, has an insertion-side opening 11a on the lower side in the vertical direction Z, and a limiting-side opening 11b on the upper side in the vertical direction Z, which is the side opposite to the insertion-side opening 11a.

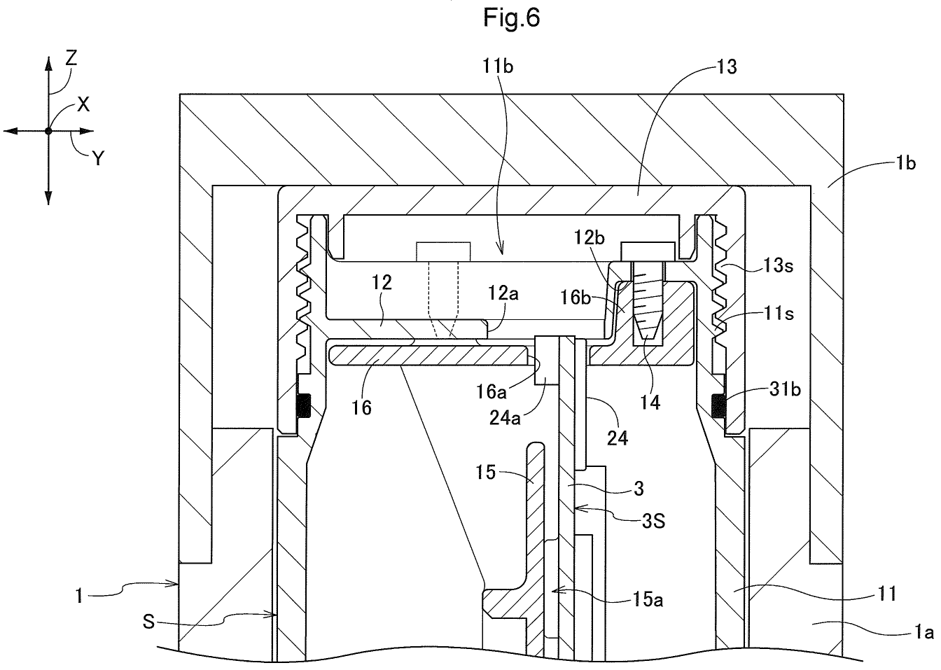

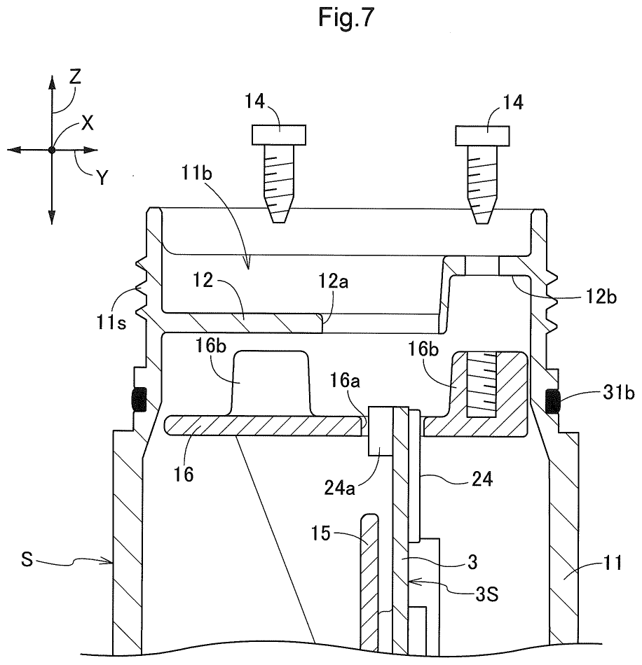

The body case 11 has a limiting wall 12 on the inside at a position in the vicinity of the limiting-side opening 11b. As shown in FIGS. 6 and 7, the limiting wall 12 has a limiting wall opening 12a that is a through hole. The limiting wall 12 has a plurality of (three in the present embodiment) engagement recesses 12b recessed along the vertical direction Z (upward in the vertical direction Z). Also, the body case 11 has a male thread portion 11s formed on the outer periphery in the vicinity of the limiting-side opening 11b.

When a cap 13 having a female thread portion 13s on the inner peripheral surface is screwed onto the male thread portion 11s, the limiting-side opening 11b of the body case 11 becomes closed. The method for attaching the cap 13 to the body case 11 is not limited to screwing, and any method may be used as long as the limiting-side opening 11b becomes closed.

In this manner, in the module case 10, while the limiting-side opening 11b of the body case 11 is closed by the cap 13, the gap between the outer peripheral surface of the body case 11 and the inner peripheral surface of the cap 13 is sealed by an annular seal 31b (an example of a second annular seal).

As shown in FIGS. 2, 3, and 5, the first battery pack 4a, which is one of the batteries 4, and the second battery pack 4b, which is another one of the batteries 4, are housed in the body case 11. As a specific arrangement, as shown in FIG. 2, the first battery pack 4a is arranged on a battery arrangement portion 15b of the inner frame 15, the second battery pack 4b is arranged on a battery arrangement space 15g formed between the body case 11 and the reverse side of the substrate surface 3S of the substrate 3, in the inner frame 15, and the first battery pack 4a and the second battery pack 4b are fixed to the inner frame 15. The battery 4 may be at least one primary battery or a secondary battery, and may be configured to supply power based on power obtained by at least either self-power generation or contactless power supply. Self-power generation is, for example, photovoltaic power generation, thermal power generation, or ambient power generation utilizing kinetic energy such as vibration. In this case, the battery 4 may be configured using a self-generating power element. Contactless power supply refers to power supply that is performed via, for example, a wireless power supply receiving coil and a rod-shaped receiving antenna, a horn-shaped receiving antenna, or a receiving antenna formed as a pattern on a substrate, without contact between the terminals. Of course, a configuration using another element having a power supply function is also possible.

In the present embodiment, the first battery pack 4a is capable of outputting a predetermined voltage, and the second battery pack 4b is capable of outputting the same voltage as the first battery pack 4a or a different voltage (e.g., approximately ½ the voltage of the first battery pack 4a).

### Inner Frame of Sensor Module

As shown in FIGS. 2, 3, and 5 to 7, the inner frame 15 has an inner wall 16 integrated with the upper end in the vertical direction Z (hereinafter sometimes referred to as the leading end portion). As shown in FIGS. 2, 3 and 8, the inner frame 15 has an outer wall 17 integrated with the end portion opposite to the inner wall 16 (hereinafter sometimes referred to as the rear end portion). The inner wall 16 and the outer wall 17 are shaped as plates orthogonal to the vertical direction Z.

The inner wall 16 has an inner wall opening 16a that is a through hole. Also, the inner wall 16 has a plurality of (three in the present embodiment) engagement protrusions 16b protruding along the vertical direction Z. The engagement protrusions 16b are disposed at positions where they can engage with the above-described engagement recesses 12b, in a view along the vertical direction Z.

With this configuration, in the module case 10, when the inner frame 15 is inserted into the body case 11 and the engagement protrusions 16b engage with the engagement recesses 12b, the posture of the inner frame 15 relative to the peripheral direction of the body case 11 (hereinafter simply referred to as the “relative posture”) is determined.

By determining the relative posture in this manner, in the module case 10, the limiting wall opening 12a of the limiting wall 12 and the inner wall opening 16a of the inner wall 16 overlap each other in a view along the vertical direction Z. In the present embodiment, the opening area of the limiting wall opening 12a is set to be larger than the opening area of the inner wall opening 16a, but the opening areas may be the same, or the opening area of the limiting wall opening 12a may be smaller than the opening area of the inner wall opening 16a, and it is only necessary that the limiting wall opening 12a and the inner wall opening 16a at least partially overlap each other in a view along the vertical direction Z.

In the module case 10, when the inner frame 15 is inserted into the body case 11 and the engagement protrusions 16b are fitted into the engagement recesses 12b as shown in FIG. 6, the protruding ends of the engagement protrusions 16b come into contact with the bottoms of the engagement recesses 12b, and the insertion limit of the inner frame 15 is determined.

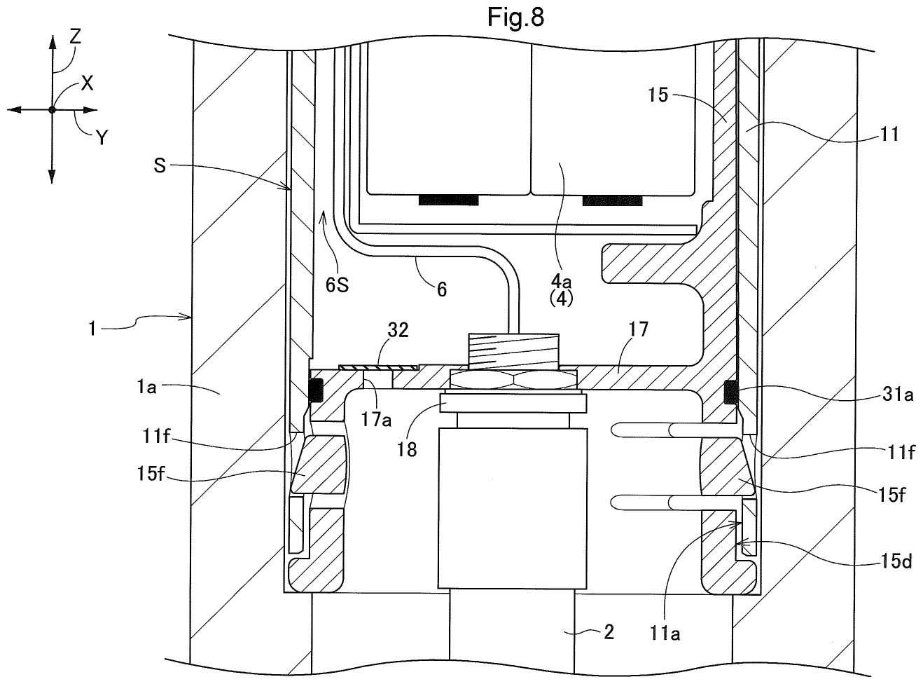

In the module case 10, when the inner frame 15 is inserted into the body case 11 up to the insertion limit, the inner wall 16 reaches a state of being close to the limiting wall opening 12a. Also, in the module case 10, when the inner frame 15 is inserted up to the insertion limit, engagement holes 11f and the engagement protrusions 15f reach a state of being engaged with each other as shown in FIG. 8, and the inner frame 15 is thereby held in the body case 11. At this time, if the inner frame 15 has not reached the insertion limit, the inner frame 15 can rotate within the body case 11, and therefore it is preferable to check that the inner frame 15 cannot rotate during insertion for assembly.

In other words, the engagement protrusions 15f can be displaced radially inward by utilizing elastic deformation of the material forming the inner frame 15, and are elastically displaced radially inward when the leading end portion of the inner frame 15 is inserted into the body case 11. When the inner frame 15 reaches the insertion limit in this elastically displaced state, the engagement protrusions 15f undergo elastic restoration radially outward and engage with the engagement holes 11f.

Note that the insertion limit of the inner frame 15 at which the engagement state is reached can be selected by design as a limit reached either when the protruding ends of the engagement protrusions 16b come into contact with the bottoms of the engagement recesses 12b, or when the inner wall 16 comes into contact with the limiting wall 12, or when a flange portion 15e at the upper end of the inner frame 15 comes into contact with the upper end of the body case 11. Also, by combining the number and positions of the engagement holes 11f and the engagement protrusions 15f, and the number and positions of the engagement recesses 12b and the engagement protrusions 16b, it is possible to design the inner frame 15 such that the inner frame 15 can only be inserted up to the insertion limit in a predetermined direction inside the body case 11 (a direction in which the substrate surface 3S is perpendicular to the front-rear direction Y). Also, by giving the body case 11 an exterior shape in which part of the cylinder has been cut out (D cut), and by cutting out part of the cylinder of a rear end tubular portion 15d of the inner frame 15 (D cut), it is possible to specify the direction in which insertion is possible, thereby making it easy to achieve insertion up to the insertion limit at which the engagement state is reached.

As shown in FIG. 6, bolt insertion holes are formed in the bottom portions of the engagement recesses 12b, and recesses are formed in the engagement protrusions 16b. Accordingly, the positions of the body case 11 and the inner frame 15 in the vertical direction Z are fixed by inserting bolts 14 into the respective bolt insertion holes and screwing them into the recesses of the engagement protrusions 16b.

As shown in FIG. 2, the inner frame 15 has, between the inner wall 16 and the outer wall 17, a substrate arrangement portion 15a on which the substrate 3 is arranged on one side in the front-rear direction Y (the right side relative to the front-rear direction Y in FIG. 2), a battery arrangement portion 15b on which a battery 4 (the first battery pack 4a described later) is arranged on the other side in the front-rear direction Y (the left side relative to the front-rear direction Y in FIG. 2), and an intermediate wall portion 15c arranged between them.

The inner frame 15 has a battery arrangement space 15g in which a battery 4 (the second battery pack 4b described later) is arranged on the reverse side of the substrate surface 3S of the substrate 3 in the body case 11.

The battery arrangement portion 15b has a structure in which the lower surface direction of the substrate 3 (the left side relative to the front-rear direction Y in FIG. 2) is open. The battery arrangement space 15g is surrounded by the body case 11 on the side of the substrate arrangement portion 15a opposite to the substrate 3 (i.e., on the left side relative to the front-rear direction Y in FIG. 2).

The inner wall 16 is disk-shaped and is close to the inner periphery of the body case 11 near the limiting-side opening 11b when the inner frame 15 is inserted up to the insertion limit as shown in FIG. 6. Also, the rear end tubular portion 15d of the outer wall 17 of the inner frame 15 is cylindrical and, as shown in FIG. 8, is close to the inner periphery of the insertion-side opening 11a of the body case 11 when the inner frame 15 is inserted up to the insertion limit.

In particular, in the module case 10, as partially described above, when the inner frame 15 has been inserted into the body case 11 up to the insertion limit, the engagement protrusions 15f of the inner frame 15 are fitted into the engagement holes 11f of the body case 11, and the inner frame 15 is thereby held relative to the body case 11.

As shown in FIGS. 2 and 6, in the module case 10, when the inner frame 15 has been inserted into the body case 11 up to the insertion limit, the position of the inner frame 15 in the vertical direction Z relative to the body case 11 is fixed by inserting bolts 14 into bolt insertion holes in the bottom portions of the engagement recesses 12b of the limiting wall 12 and screwing the bolts 14 into recesses of the inner wall 16.

When the inner frame 15 has been inserted into and fixed to the body case 11, an annular seal 31a (an example of a first annular seal) is located between the inner peripheral surface of the insertion-side opening 11a of the body case 11 and the outer peripheral surface of the rear end tubular portion 15d of the inner frame 15 to seal the gap between them (see FIG. 8). Note that the annular seal 31a disposed between the outer peripheral surface of the rear end tubular portion 15d and the inner peripheral surface of the insertion-side opening 11a may have the same specifications as the annular seal 31b disposed between the outer peripheral surface of the body case 11 and the inner peripheral surface of the cap 13, or may have different specifications with a different size, cross-sectional shape, material, or the like.

As shown in FIGS. 2, 3 and 8, the outer wall 17 includes an external connector 18 at a center position. The external cable 2 is connected to the outer end of the external connector 18. The outer wall 17 has a through hole 17a, and the through hole 17a is closed with a membrane 32 (e.g., a porous film) that allows air to pass through but does not allow water to pass through.

By providing the membrane 32 in this manner, even if the air pressure outside the module case 10 changes, the pressure inside the module case 10 remains equal to the pressure outside the module case 10 (air pressure).

### Substrate of Inner Frame

As shown in FIGS. 2, 4 and 5, the substrate arrangement portion 15a of the inner frame 15 is plate-shaped, and the substrate 3 is arranged in a posture parallel to the surface of the plate.

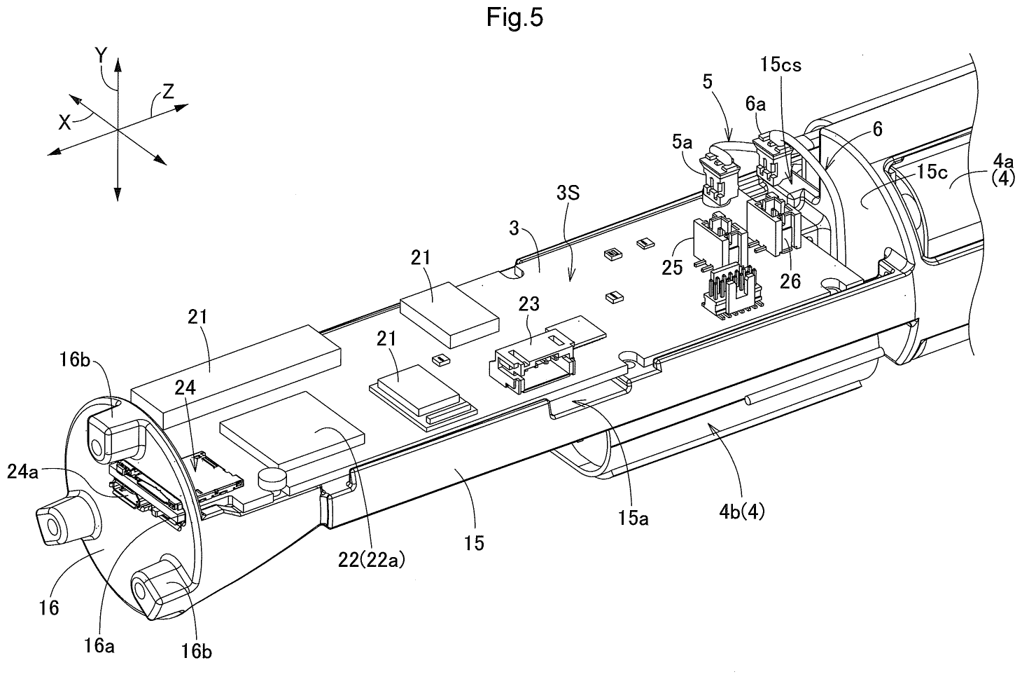

The substrate 3 has the substrate surface 3S, and, as shown in FIGS. 3 and 5, a plurality of sensor units 21, a wireless communication unit 22, a card connector 23, a connector unit 24, a power connector 25, and an information connector 26 are mounted on the substrate surface 3S.

In particular, the power connector 25 and the information connector 26 are disposed close to the lower end portion, in the vertical direction Z, of the substrate surface 3S of the substrate 3. The substrate 3 also includes a one-chip microcomputer that controls the sensor module S, a memory, and the like (not shown).

The sensor units 21 may be a unit having a global positioning system (GPS), or may be a temperature sensor that obtains the air temperature, a pressure sensor that obtains a pressure such as the air pressure, a vibration sensor that detects vibration, or the like.

The sensor module S can use, as the sensor units 21, non-contact sensors such as a millimeter wave sensor that detects millimeter waves, a magnetic sensor that detects magnetic fields, a temperature sensor that detects temperature, an acceleration sensor that detects acceleration, and a gyro sensor that detects position changes. These sensors are set as specifications of the sensor module S.

Note that examples of magnetic sensors include a hall sensor using the hall effect, an MR sensor, and an MI sensor. The pressure sensor may be a capacitance type of sensor or a piezoresistance type of sensor.

In a modified example, the sensor module S can be configured such that the sensor units 21 inside the body case 11 measure the distance to an external detection target, capture external images, or capture external light rays or the like. To realize such a modified example, openings are formed in the outer case 1 and the body case 11, in order to be able to use an ultrasonic distance sensor or the like for measuring the distance to an object in the sensor units 21, an image sensor for capturing image information, or the like, and it is also possible to receive information acquired by an external sensor connected to the external cable 2.

The wireless communication unit 22 includes an antenna unit 22a so as to enable transmission and reception of signals via wireless communication. In this way, the wireless communication unit 22 is not limited to being constituted by a single component as shown in FIG. 3, but may also form the antenna unit 22a formed as part of the printed wiring on the substrate surface 3S of the substrate 3, or the wireless communication unit 22 may also be configured to include a plurality of components and the antenna unit 22a for transmission and reception, which are provided separately on the substrate surface 3S of the substrate 3, or the wireless communication unit 22 may be an antenna module connected to the substrate 3 by an electric wire.

The wireless communication unit 22 is a unit that enables the use of LPWA (abbreviation for Low Power Wide Area) as a long-distance wireless standard, a mobile communication technology standard called 5G, or LTE (abbreviation for Long Term Evolution) as a mobile phone communication standard, for example.

These communication technologies are implemented by utilizing the communication lines of a communication carrier (a communication line operator). To achieve this, a SIM card (not shown), which is storing information such as information on a communication carrier with which a contract has been made to use a communication line, is inserted into the card connector 23. Note that SIM is an abbreviation for Subscriber Identity Module.

Also, the wireless communication unit 22 may use communication technology such as WiFi technology (WiFi is a registered trademark related to wireless LANs) or Bluetooth (registered trademark) as a short-range wireless standard, and may be configured to be compatible with both long-range and short-range wireless standards.

The connector unit 24 is disposed at the upper end portion of the substrate 3, and enables control of access to information via a terminal 24a on the reverse side of the substrate surface 3S. The terminal 24a is compliant with the USB (Universal Serial Bus, registered trademark) standard and is disposed at a position partially fitted inside the inner wall opening 16a of the inner wall 16.

In the module case 10, when the inner frame 15 has been inserted into the body case 11 up to the insertion limit, the limiting wall opening 12a and the inner wall opening 16a are in a positional relationship of being close to and overlapping each other. For this reason, the module case 10 is configured such that a USB-standard plug can be inserted through the limiting wall opening 12a and the inner wall opening 16a and connected to the terminal 24a of the connector unit 24.

The power connector 25 receives power from a battery 4 when connected to a power plug portion 5a of a power cable 5 extending from the first battery pack 4a. As shown in FIG. 5, the power cable 5 is inserted through an opening 15cs formed by cutting out a part of the intermediate wall portion 15c. Also, in the case where the power cable 5 does not have the power plug portion 5a at the leading end portion and is electrically connected by being directly soldered to the substrate 3, the substrate 3 may have a through-hole electrode or a surface electrode formed by a pattern, instead of the power connector 25.

An information plug portion 6a of an information cable 6 extending from the external connector 18 is connected to the information connector 26, and external information is transmitted via the external cable 2 connected to the external connector 18. The information cable 6 is disposed in a cable space 6S formed between the outer surface of the first battery pack 4a and the inner surface of the body case 11 in the battery arrangement portion 15b as shown in FIG. 2. Note that in the case where the information cable 6 does not have the information plug portion 6a at the leading end portion and is electrically connected by being directly soldered to the substrate 3, the substrate 3 may have a through hole electrode or a surface electrode formed by a pattern, instead of the information connector 26.

### Battery Arrangement Portion of Inner Frame, etc.

As described above, the sensor module S uses, as the batteries 4, the first battery pack 4a and the second battery pack 4b having the same voltage as the first battery pack 4a or a different voltage.

As shown in FIGS. 2 and 3, the battery arrangement portion 15b of the inner frame 15 has a wall structure in which a portion of the outer wall is close to the inner peripheral surface of the body case 11, and the first battery pack 4a is arranged so as to be at least partially housed inside the wall structure.

The first battery pack 4a and the second battery pack 4b each include a plurality of primary or secondary batteries that are integrated using a film, tape, a case, or the like.

As partially described above, the first battery pack 4a is arranged on the battery arrangement portion 15b of the inner frame 15, and the second battery pack 4b is arranged in the battery arrangement space 15g on the reverse side of the substrate 3, in the inner frame 15. The first battery pack 4a and the second battery pack 4b are fixed to the inner frame 15 using screws or a battery case, but the method of fixing the first battery pack 4a and the second battery pack 4b to the inner frame 15 is not limited to these examples.

The wireless communication unit 22 includes the antenna unit 22a, and the antenna unit 22a emits strong wireless signals in a direction perpendicular to the substrate surface 3S of the substrate 3. For this reason, the area that strongly emits wireless signals will be referred to as a transmission area E, as shown in FIGS. 2 and 3.

In the sensor module S, the first battery pack 4a and the second battery pack 4b are arranged at positions not overlapping the antenna unit 22a in a view along a direction perpendicular to the substrate surface 3S of the substrate 3. Furthermore, in the sensor module S, in order to efficiently send out wireless signals emitted from the antenna unit 22a, the batteries 4 (the first battery pack 4a and the second battery pack 4b) are arranged at positions not overlapping the transmission area E in a view along a direction perpendicular to the substrate surface 3S of the substrate 3.

By setting the positional relationship between the antenna unit 22a and the batteries 4 in this manner, the management unit is able to receive wireless signals emitted from the antenna unit 22a without the signals being blocked by the batteries 4 and being significantly attenuated.

### Method for Assembling Sensor Module

Next, a method for assembling the sensor module S will be described. When assembling the sensor module S, the substrate 3, having mounted thereon the sensor units 21, the wireless communication unit 22, the card connector 23, the connector unit 24, the power connector 25, the information connector 26, and the like, is fixed to the substrate arrangement portion 15a of the inner frame 15 with screws or the like (not shown).

The first battery pack 4a is housed in and fixed to the battery arrangement portion 15b of the inner frame 15, and the second battery pack 4b is fixed in the battery arrangement space 15g on the rear side of the substrate surface 3S of the substrate 3. Also, the external connector 18 is fixed to the outer wall 17 of the inner frame 15. In this state, as shown in FIGS. 2 and 3, the power plug portion 5a of the power cable 5, which transmits power from the first battery pack 4a, is connected to the power connector 25 of the substrate 3, and the information plug portion 6a of the information cable 6, which transmits information from the external connector 18, is connected to the information connector 26 of the substrate 3.

Next, the inner frame 15 is inserted in the vertical direction Z through the insertion-side opening 11a of the body case 11, the body case 11 and the inner frame 15 are rotated relative to each other along the peripheral direction of the body case 11, centered on the vertical direction Z, such that the engagement protrusions 16b of the inner wall 16 on the leading end side engage with the engagement recesses 12b of the limiting wall 12 of the body case 11, and the inner frame 15 is inserted such that the position of the D-cut shape of the body case 11 and the position of the D-cut shape of the rear end tubular portion 15d of the inner frame 15 are aligned with each other.

Due to such insertion, the engagement protrusions 16b engage with the engagement recesses 12b, and the protruding ends of the engagement protrusions 16b come into contact with the bottoms of the engagement recesses 12b, and thus the inner frame 15 reaches the insertion limit.

When the body case 11 reaches the insertion limit, the engagement protrusions 15f formed on the rear end portion of the inner frame 15 engage with the engagement holes 11f formed close to the insertion-side opening 11a of the body case 11, and the inner frame 15 is held relative to the body case 11. When the insertion limit is thus reached, the bolts 14 are inserted into the bolt insertion holes in the bottom portions of the engagement recesses 12b and screwed into recesses of the engagement protrusions 16b, thereby fixing the inner frame 15 to the body case 11.

Note that when inserting the inner frame 15 into the body case 11, the inner frame 15 is inserted with the annular seal 31a attached to the rear end tubular portion 15d of the inner frame 15 such that the annular seal 31a is positioned between the inner peripheral surface of the insertion-side opening 11a of the body case 11 and the outer peripheral surface of the rear end tubular portion 15d of the inner frame 15.

In this manner, the inner frame 15 is housed in and fixed to the body case 11. Then, with the annular seal 31b attached to the outer peripheral surface of the limiting-side opening 11b of the body case 11, the female thread portion 13s of the cap 13 is screwed to the male thread portion 11s of the body case 11. Furthermore, the cap 13 is fixed with the annular seal 31b disposed between the outer peripheral surface of the limiting-side opening 11b and the inner peripheral surface of the cap 13.

This completes the assembly of the module case 10, in which the inner frame 15 is housed in the body case 11.

The sensor module S assembled in this manner is housed in the outer case 1 in a posture in which the cap 13 of the body case 11 faces upward. When an external sensor or the like is used, the external cable 2 is connected to the external connector 18 and is drawn out to the outside of the outer case 1.

The sensor module S housed in the outer case 1 in this manner is installed in the posture shown in FIG. 1 and used at a work site in a factory or at any indoor or outdoor location where environmental information needs to be obtained. The external cable 2 enables obtaining information about the environment in an area at a distance from the outer case 1 by the external sensor or the like.

### Effects of Embodiment

### (1) Battery and Wireless Communication Unit

The sensor module S includes the module case 10 that houses the sensor units 21, the wireless communication unit 22, and the batteries 4 for supplying power. In particular, since the batteries 4 are the largest components of the sensor module S, by arranging the batteries 4 at positions not overlapping the transmission area E, which is based on the antenna unit 22a of the wireless communication unit 22, the transmission of information via wireless communication is not hindered.

Also, since the sensor module S includes the batteries 4 (the first battery pack 4a and the second battery pack 4b), information acquired by the sensor module S can be transmitted to an external device via wireless communication without requiring an external supply of power. Furthermore, the first battery pack 4a and the second battery pack 4b can be set to output different voltages and can each be used as a power source, and the second battery pack 4b can be used as an auxiliary battery to extend the battery life of the first battery pack 4a or can be used to increase the overall voltage of the batteries 4, thus making it possible to satisfy the required battery life and the specifications of the power supply voltage required for the sensor module S.

### (2) Battery Arrangement

The inner frame 15 has a structure in which the battery arrangement portion 15b and the battery arrangement space 15g are offset in the vertical direction Z, and the first battery pack 4a and the second battery pack 4b can be attached and detached in a direction perpendicular to the substrate surface 3S of the substrate 3. For this reason, when replacing the first battery pack 4a and the second battery pack 4b, the inner frame 15 is removed from the body case 11, and, for example, the screws that secure the first battery pack 4a and the second battery pack 4b individually from each other are removed, and the first battery pack 4a and the second battery pack 4b are removed and replaced.

Furthermore, since the first battery pack 4a and the second battery pack 4b are attached to the inner frame 15 from the direction opposite to the substrate 3, there is no need to remove the substrate 3 from the inner frame 15 every time the first battery pack 4a or the second battery pack 4b is replaced due to end of battery life or the like. In other words, there is no need to give consideration to repeatedly removing the substrate 3 from the inner frame 15 in order to attach the substrate 3 to the inner frame 15, and it is possible to fix the substrate 3 to the inner frame 15 using tapping screws, adhesive, or the like.

### (3) Connector Unit

With the sensor module S, by removing the cap 13, the inner wall opening 16a is exposed inside the opening of the limiting wall opening 12a, and the terminal 24a of the connector unit 24 is exposed in the inner wall opening 16a. Due to this positional relationship, a USB-standard plug can be easily connected to the terminal 24a of the connector unit 24 from outside the limiting wall 12.

This allows, for example, firmware stored in a memory such as a one-chip microcomputer to be easily updated, and also makes it possible to charge the batteries 4.

Furthermore, by using the connector unit 24 that is configured to be able to acquire information from an IC card, for example, it is possible to use the connector unit 24 for wireless communication standard authentication. Furthermore, by mounting a storage medium such as a flash memory as an IC card, it is possible to store information acquired by the sensor units 21 in the storage medium.

### (4) External Cable

By connecting the external cable 2 to an external sensor (not shown), information acquired by the external sensor can be provided to the sensor module S, thereby expanding the area in which information can be acquired, and the number of types of information that can be acquired. Also, the range of sensing targets can be expanded by using external sensors that are not provided on the substrate 3 but are connected to the external cable 2, such as a water level sensor that detects the water level of a river or a lake, an air flow sensor that detects air flow, a gas sensor that detects the concentration of a specific gas contained in the air, a soil moisture sensor that measures the moisture content of soil, or a soil salinity sensor that measures the salinity concentration of soil.

Moreover, the external cable 2 can also be used to charge the batteries 4 with power received from an external power source, thereby making it possible to extend the length of time that the information acquisition unit A can be used.

### (5) Relationship Between Substrate and Cable

By connecting the power plug portion 5a of the power cable 5, which extends from the first battery pack 4a, to the power connector 25 of the substrate 3, the substrate 3 can receive power from the batteries 4. Since the power cable 5 is inserted through the opening 15cs formed by cutting out a portion of the intermediate wall portion 15c as shown in FIG. 5, the power cable 5 can be arranged easily.

Furthermore, by connecting the information plug portion 6a of the information cable 6, which is connected to the external connector 18, to the information connector 26 of the substrate 3, information can be transmitted to the substrate 3. Since the information cable 6 is inserted through the cable space 6S between the outer surface of the first battery pack 4a and the inner surface of the body case 11, the information cable 6 can be arranged easily.

### (6) Sensor Module

The sensor module S is not limited to being configured to simply transmit information detected by the sensor units 21 via wireless communication, but can also be configured to, for example, calculate the propagation speed of sound waves traveling through the air based on air temperature information and transmit the result via wireless communication.

Similarly, in the case where a plurality of information acquisition units A are used, for example, when earthquake vibrations are detected by a vibration sensor, it is possible to configure the information acquisition units A to estimate the epicenter by calculation based on the difference in timing at which the vibrations are detected by the installed information acquisition units A, the direction of the vibrations, the magnitude of the vibrations, and the like, and to transmit the result via wireless communication. Furthermore, it is possible to compare information obtained by a plurality of information acquisition units A and perform analysis based on the relative difference in information between the information acquisition units.

### (7) Sealing Structure

The sensor module S is configured as the module case 10 having a structure in which the inner frame 15 is inserted into the cylindrical body case 11. The module case 10 maintains the internal space of the body case 11 in a watertight and airtight state by sealing the limiting-side opening 11b of the body case 11 with the annular seal 31b and the cap 13, and sealing the insertion-side opening 11a of the body case 11 with the annular seal 31a.

Such a sealed structure makes it possible to prevent problems with the sensor module S such as current leakage from the batteries 4 due to the influence of water, and to prevent malfunction of the sensors provided on the substrate 3. Furthermore, it is possible to prevent dust from entering from the outside, thus preventing a decrease in sensor detection performance.

In particular, since the outer wall 17 of the inner frame 15 is sealed with the membrane 32 that allows air to pass through but does not allow water to pass through, when the air pressure outside the module case 10 changes, the air pressure inside and outside the module case 10 becomes equal, thereby making it possible to measure the outside air pressure with the sensor units 21 while maintaining an airtight state.

### Other Embodiments

Aspects of this disclosure may be configured as follows in addition to the above-described embodiment (components having the same functions as in the embodiments are denoted by the same numbers and symbols as in the embodiment).
(a) The sensor module S may be configured to use only a single case as the module case 10. In the above embodiment, the module case 10 is configured by the body case 11 and the inner frame 15, but in this alternative embodiment (a), for example, it is also conceivable to configure the sensor module S by housing the substrate 3 and the batteries 4 in the body case 11 and sealing both end portions of the body case 11 with a lid-like member or the like.
(b) The antenna unit 22a is configured by using part of the metal foil wiring pattern formed on the substrate surface 3S as the antenna unit 22a, or by providing a conductive member on the substrate surface 3S. With this configuration, it is also possible to impart directivity using the shape of the wiring pattern.
(c) In the above embodiment, the batteries 4 are arranged in areas that do not overlap with the transmission area E. Since the wireless communication unit 22 emits wireless signals (radio waves) in directions all around the body case 11, it is also conceivable to configure the batteries 4 so as to not overlap the wireless communication unit 22 in a view along a direction along the substrate surface 3S (lateral direction X). Such a configuration enables better transmission of wireless signals (radio waves).
(d) The number of batteries 4 housed in the body case 11 can be set as desired. Also, this sensor module S can be designed such that the length along the vertical direction Z of the body case 11 can be set arbitrarily, and therefore, by expanding the length of the body case 11, a large number of batteries 4 can be housed, thereby lengthening the time for which the sensor module S can be used.

Note that the configurations disclosed in the above embodiments (including other embodiments, which similarly applies below) can be applied in combination with configurations disclosed in other embodiments, as long as no contradiction arises, and furthermore, the embodiments disclosed in this specification are merely examples, and the embodiments of this disclosure are not limited thereto, and can be appropriately modified within the scope of this disclosure.

1. A sensor module comprising:
a module case;
a sensor unit mounted on a substrate surface of a substrate housed in the module case;
a wireless communication unit mounted on the substrate surface; and
a battery housed in the module case and configured to supply power to the sensor unit and the wireless communication unit,
the battery being arranged at a position not overlapping the wireless communication unit in a view along a direction perpendicular to the substrate surface of the substrate.

2. The sensor module according to claim 1,
wherein the wireless communication unit includes an antenna unit, and
the battery is arranged at a position not overlapping the antenna unit in a view along the direction perpendicular to the substrate surface of the substrate.

3. The sensor module according to claim 1,
wherein the module case includes:
a tubular body case having an insertion-side opening in at least one end portion; and
an inner frame configured to be housed in the body case by being inserted through the insertion-side opening, and
the inner frame includes:
a substrate arrangement portion extending in a direction in which the inner frame is inserted into the body case, and on which the substrate is disposed on a first side in the direction perpendicular to the substrate surface;
a battery arrangement portion on which the battery is disposed from a second side in the direction perpendicular to the substrate surface; and
an intermediate wall portion disposed between the substrate arrangement portion and the battery arrangement portion.

4. The sensor module according to claim 2,
wherein the module case includes:
a tubular body case having an insertion-side opening in at least one end portion; and
an inner frame configured to be housed in the body case by being inserted through the insertion-side opening, and
the inner frame includes:
a substrate arrangement portion extending in a direction in which the inner frame is inserted into the body case, and on which the substrate is disposed on a first side in the direction perpendicular to the substrate surface;
a battery arrangement portion on which the battery is disposed from a second side in the direction perpendicular to the substrate surface; and
an intermediate wall portion disposed between the substrate arrangement portion and the battery arrangement portion.

5. The sensor module according to claim 3,
wherein the intermediate wall portion has an opening into which a power cable is insertable, the power cable being configured to supply power from the battery disposed on the battery arrangement portion to the substrate.

6. The sensor module according to claim 4,
wherein the intermediate wall portion has an opening into which a power cable is insertable, the power cable being configured to supply power from the battery disposed on the battery arrangement portion to the substrate.

7. The sensor module according to claim 5,
wherein the substrate includes a power connector connectable to a power plug portion connected to the power cable, the power connector being provided on the substrate surface.

8. The sensor module according to claim 6,
wherein the substrate includes a power connector connectable to a power plug portion connected to the power cable, the power connector being provided on the substrate surface.

9. The sensor module according to claim 3,
wherein the inner frame further includes an external connector at a position exposed through the insertion-side opening after the inner frame is inserted through the insertion-side opening of the body case, and
the sensor module further has a cable space formed on a lateral side of the battery in the battery arrangement portion in response to the inner frame being inserted into the body case, the cable space being configured to accommodate an information cable configured to electrically connect the external connector and the substrate to each other.

10. The sensor module according to claim 4,
wherein the inner frame further includes an external connector at a position exposed through the insertion-side opening after the inner frame is inserted through the insertion-side opening of the body case, and
the sensor module further has a cable space formed on a lateral side of the battery in the battery arrangement portion in response to the inner frame being inserted into the body case, the cable space being configured to accommodate an information cable configured to electrically connect the external connector and the substrate to each other.

11. The sensor module according to claim 5,
wherein the inner frame further includes an external connector at a position exposed through the insertion-side opening after the inner frame is inserted through the insertion-side opening of the body case, and
the sensor module further has a cable space formed on a lateral side of the battery in the battery arrangement portion in response to the inner frame being inserted into the body case, the cable space being configured to accommodate an information cable configured to electrically connect the external connector and the substrate to each other.

12. The sensor module according to claim 6,
wherein the inner frame further includes an external connector at a position exposed through the insertion-side opening after the inner frame is inserted through the insertion-side opening of the body case, and
the sensor module further has a cable space formed on a lateral side of the battery in the battery arrangement portion in response to the inner frame being inserted into the body case, the cable space being configured to accommodate an information cable configured to electrically connect the external connector and the substrate to each other.

13. The sensor module according to claim 7,
wherein the inner frame further includes an external connector at a position exposed through the insertion-side opening after the inner frame is inserted through the insertion-side opening of the body case, and
the sensor module further has a cable space formed on a lateral side of the battery in the battery arrangement portion in response to the inner frame being inserted into the body case, the cable space being configured to accommodate an information cable configured to electrically connect the external connector and the substrate to each other.

14. The sensor module according to claim 8,
wherein the inner frame further includes an external connector at a position exposed through the insertion-side opening after the inner frame is inserted through the insertion-side opening of the body case, and
the sensor module further has a cable space formed on a lateral side of the battery in the battery arrangement portion in response to the inner frame being inserted into the body case, the cable space being configured to accommodate an information cable configured to electrically connect the external connector and the substrate to each other.

15. The sensor module according to claim 9,
wherein the sensor unit, the wireless communication unit, and an information connector connectable to a connection plug portion connected to the information cable are mounted on the same substrate surface of the substrate.

16. The sensor module according to claim 10,
wherein the sensor unit, the wireless communication unit, and an information connector connectable to a connection plug portion connected to the information cable are mounted on the same substrate surface of the substrate.

17. The sensor module according to claim 11,
wherein the sensor unit, the wireless communication unit, and an information connector connectable to a connection plug portion connected to the information cable are mounted on the same substrate surface of the substrate.

18. The sensor module according to claim 3,
wherein the body case has a through hole-shaped limiting wall opening in a limiting wall determining an insertion limit in response to the inner frame being inserted into the body case,
the inner frame has a through hole-shaped inner wall opening in an inner wall adjacent to or in contact with the limiting wall in response to the inner frame being inserted up to the insertion limit, and
the limiting wall opening and the inner wall opening are in an overlapping positional relationship in response to the inner frame being inserted up to the insertion limit.

19. The sensor module according to claim 18, further comprising:
a first annular seal configured to seal a gap between an outer peripheral surface of a portion of the inner frame in a vicinity of the insertion-side opening and an inner peripheral surface of the insertion-side opening of the body case while the inner frame is at the insertion limit in the body case; and
a second annular seal configured to seal a gap between an outer peripheral surface of the body case and an inner peripheral surface of a cap configured to seal a limiting-side opening of the body case, the limiting-side opening being on a side opposite to the insertion-side opening.

20. The sensor module according to claim 18,
wherein the inner frame has a through hole in an outer wall formed on an end portion on a side opposite to the inner wall in the direction in which the inner frame is inserted, the through hole being closed by a membrane that allows air to pass through and does not allow water to pass through.
